(19) United States
(12) Patent Application Publication
(10) Pub. No.: US 2006/0294073 A1
(43) Pub. Date: Dec. 28, 2006

(54) Constrained exploration for search algorithms

(75) Inventor: Youssef Hamadi, Cambridge (GB)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/170,290

(22) Filed: Jun. 28, 2005

(51) Int. Cl. G06F 17/30

(52) U.S. Cl. 707/3

(57) ABSTRACT

Partition criteria is used to direct or constrain a search process that searches a search space for solution to a problem. The identification of states for further exploration of the search space is directed by the use of reference state and distance constraint information that is part of the partition criteria. Multiple processes use the same or different partition criteria to together search relevant areas of a search space. The operation of multiple processes, including the choice of partition criteria, is coordinated by a coordination or control process. Different search topologies are implemented by selecting various partition criteria.

### BACKGROUND

A large class of problems, including those in planning, scheduling, and configuration, can be solved by search algorithms, which are algorithms that define how to search a problem space, or a “search space,” for a solution to a problem. For example, the problem of finding a suitable network topology for a number of computer systems with different attributes, different connections, and so on, may be amenable to being solved by a search algorithm. Determining a suitable schedule for a set of resources that can meet different needs is another example of a problem where the use of a search algorithm may be useful.

In general, methods for solving such problems can categorized as deterministic or non-deterministic. A deterministic method comprises a well-defined and ordered set of steps that can perform an efficient exploration of a search space to find a solution. A non-deterministic method, in contrast, explores a search space in a way that may depend on more than just the input and current state, and whose search path can't be absolutely predicted. For many problems, an efficient deterministic method does not exist, and the most suitable possible method for solving the particular problem is to use a non-deterministic method.

For many such problems, exploring a search space requires a large amount of computational resources, regardless of the nature of the search algorithm used. A common way to accelerate a search is to apply multiple individual computing resources, including computer processors with multiple cores, computers with multiple processors, and multiple computers organized in many different ways. Some deterministic algorithms lend themselves to the use of multiple computing resources—the search space may be split into multiple independent sub-spaces, each of which is then explored by an individual computing resource. In contrast, it is difficult to efficiently utilize multiple computing resources in the same way with many non-deterministic algorithms. For example, dividing the search space before beginning a non-deterministic search may not ensure exploration diversity, because it may be difficult or impossible to predict the ultimate search path of many non-deterministic algorithms—i.e., to determine, given a starting search state, which portion of the search space will be explored.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various technologies and techniques directed to methods and systems for constraining and directing the exploration of search algorithms. One application of such methods and systems on search exploration is more efficient use of multiple individual computing resources.

Exemplary embodiments described herein use multiple processes to search a space where results are to be identified. The search space is generally partitioned into regions using one or more partition criteria, which may be expressed as a reference search state and a distance measure around the reference search state that is to be searched, generally by one or more search processes. Depending on how the partition criteria is selected and assigned to the various search processes, the search topology and strategy may take on a variety of characteristics and may have overlapping search spaces, non-overlapping search spaces, or a combination of the two. In partitioning the search space, the processes may be coordinated by a coordinating or control process, which may be either one of the search processes or may be a separate control process. Alternatively, the search processes may exchange information in order to coordinate among themselves to partition the search space. The exemplary embodiments described herein may utilize any type of numerical model to evaluate a candidate search state and may utilize any type of strategy for selecting search states within a region until a suitable state is located and/or some stopping criteria is satisfied.

### DESCRIPTION OF THE DRAWINGS

FIG. 1 is an illustration of an exemplary generalized operational flow including various operations that may be performed and data that may be used by a search algorithm exploring a search space.

FIG. 2 is an illustration of an exemplary generalized system that uses one or more instances of search algorithms to explore a search space.

FIG. 3 is an illustration of an exemplary generalized operational flow including various operations that may be performed to use search algorithms to explore a search space, without a centralized partitioning agent or logic.

FIG. 4 is an illustration of an exemplary generalized representation of a system that illustrates one of many possible search topologies by showing the division of a search space into two search spaces.

FIG. 5 is an illustration of an exemplary generalized representation of a system that illustrates how a search may change over time by using new partition criteria.

FIG. 6 is an illustration of an exemplary generalized representation of a system that illustrates one of many possible divisions of a search space into three search spaces.

FIG. 7 is an illustration of an exemplary generalized representation of a system that illustrates a division into two search spaces where the reference states are not the same, and where the search spaces do not encompass all of the total search space.

FIG. 8 is an illustration of an exemplary generalized representation of a system that illustrates a division into two search spaces where the reference states are not the same, and where the resulting search spaces overlap.

FIG. 9 is an illustration of an exemplary generalized representation of a system that illustrates a division into three search spaces where the third search space is defined using partition criteria that contains multiple reference states and distance constraints.

FIG. 10 is an illustration of one possible basic implementation of a computing device.

### DETAILED DESCRIPTION

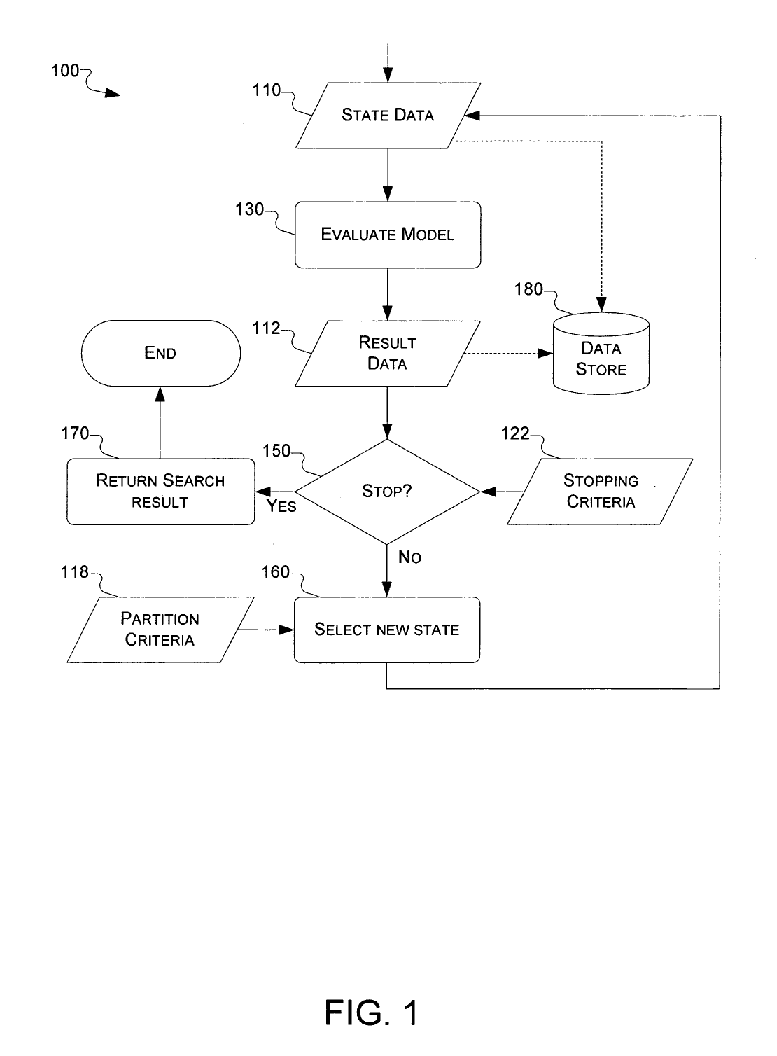

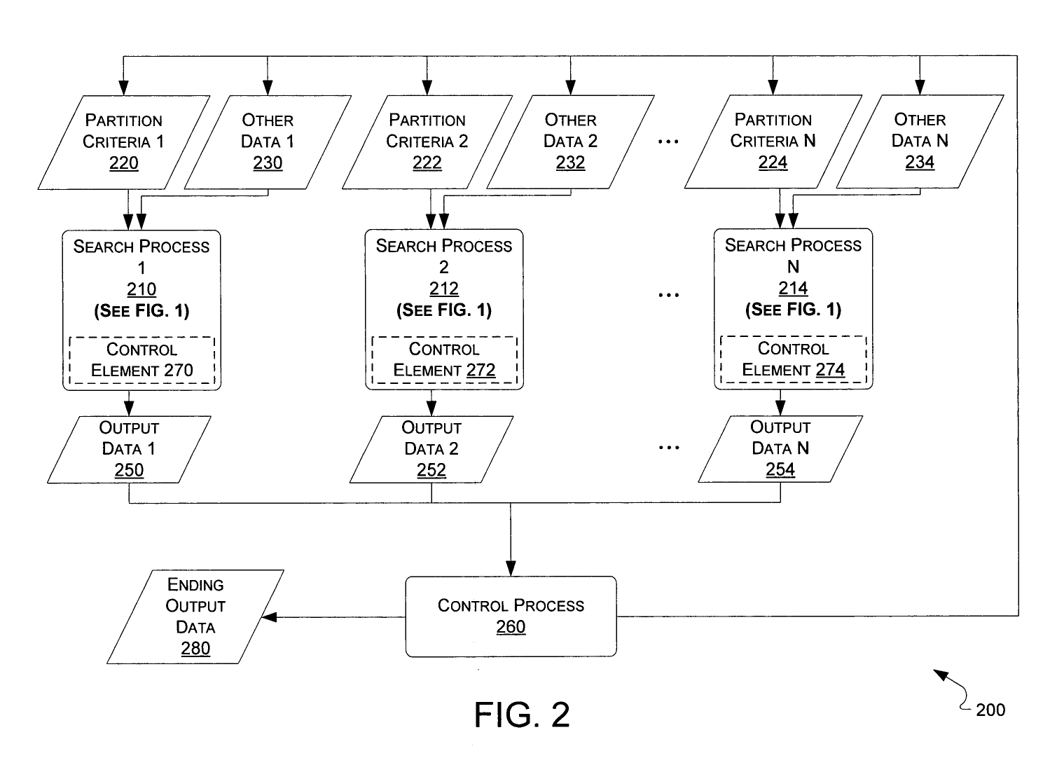

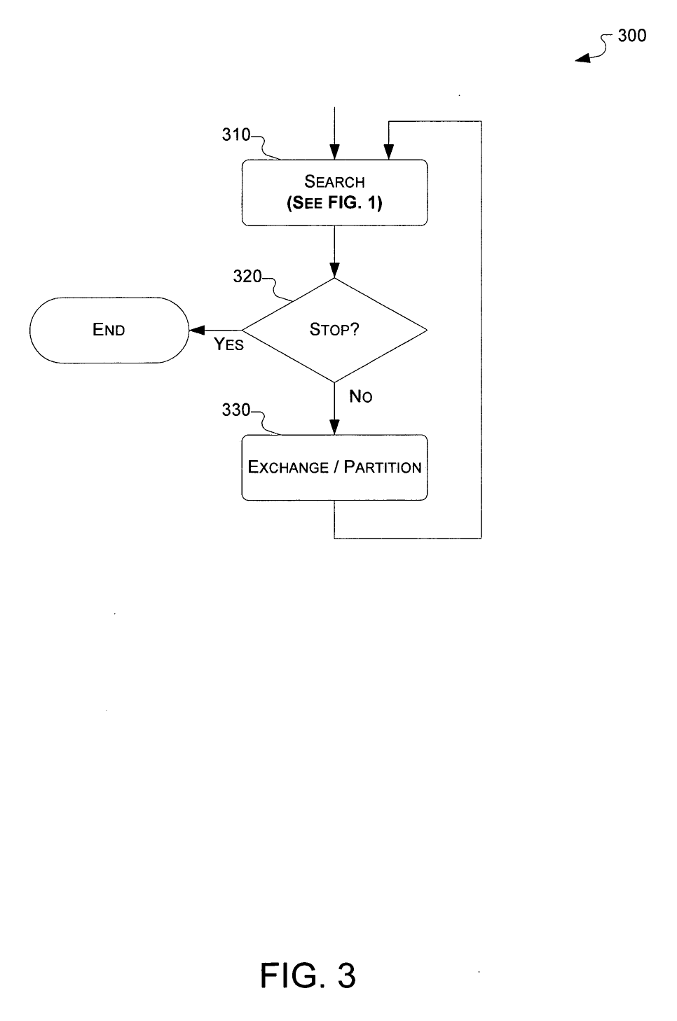

Turning to FIG. 1, shown therein is an exemplary generalized operational flow 100 including various operations that may be performed and data that may be used by a search algorithm exploring a search space. Given some state data 110, as well as other data such as stopping criteria 122 and partition criteria 118, the operational flow 100 explores the search space by evaluating a model and identifying new states.

While this description of FIG. 1 may be made with reference to other figures, it should be understood that the exemplary operational flow 100 is not intended to be limited to being associated with the systems or other contents of any specific figure or figures. Additionally, it should be understood that while the exemplary operational flow 100 indicates a particular order of operation execution, in one or more alternative implementations, the operations may be ordered differently. Furthermore, some of the steps and data illustrated in the exemplary operational flow 100 may not be necessary and may be omitted in some implementations. Finally, while the operational flow contains multiple discrete steps, it should be recognized that in some environments some of these operations may be combined and executed at the same time.

In general, a search algorithm attempts to find one or more solutions to a particular problem. Search algorithms generally work with a model. The model provides a representation of some behavior used as part of solving the problem. Given some state, the model provides a result. This result may then be evaluated for its suitability in solving the problem—some results will be better solutions to the problem than others. The search algorithm may then choose new values for the state, possibly using the existing state, the result, and the suitability of the result, as well as any number of other factors. The search algorithm may then provide this new state to the model, obtain a result, evaluate the result, and so on. This process may continue until some stopping criteria is met. For example, the process may continue until a certain number of states have been examined, until the result meets some standard of suitability, or until some other criteria is met.

In some exemplary cases, and without limitation, the problem to be solved lies in a physical domain. In some of these cases, the model may be a representation of some physical process or processes, the state provided to the model may be a codification of physical parameters, and the result generated by the model may be the result of the model's manipulation of the physical parameters. For example and without limitation, suppose that the problem to be solved involves configuring computer servers. The state provided to the model in this example may comprise the number of available servers, the speed of the servers, the amount of memory used by the servers, the speed of the networks connecting the servers, the complexity of the processing performed by the servers, and so on. Suppose that the type of these input values is represented as (A, B, C, D, E) and a particular set of state data is represented as (a, b, c, d, e), where each value corresponds to a variable in the model used to identify a solution. In this example, the model may perform a variety of calculations and provide a result that comprises the number of concurrent users that the computer servers represented by the given state can support, as well as an estimate of the average response time each user would experience while using the computer servers. Suppose that the type of a result is represented as (Y, Z) and the model, when provided with a set of input values, like (a, b, c, d, e), generates a result with output values like (y, z).

One of the factors that differentiate different search algorithms is the way in which the search algorithm identifies the next state, or states, to evaluate. Identification of the next state may be accomplished using many different methods, most or all of which may be useful in the context of this invention. For example, some search algorithms may identify the next state at random, other search algorithms may identify the next state from a family of states related in some manner to the current state, for example by using “genetic” algorithms, the “slope” of current and recent results, or some other method, and so on.

The use of a “distance constraint” when determining the next state may constrain the exploration of a search algorithm in a variety of advantageous ways. In general, a “distance constraint” may constrain an algorithm based on some measure of the “distance” or difference between two states. If a search algorithm may only identify subsequent states that meet a limitation specified by a distance constraint, the search algorithm's exploration can be limited in a variety of ways, for a variety of purposes.

In some exemplary implementations, a distance constraint or distance constraints can be used with multiple instances of one or more search algorithms so that each instance of a search algorithm explores a particular search space that is part of a total search space. In an example like this, depending on the nature of the distance constraint or constraints and the states provided to the models, overlap between different instances of the search algorithm can be avoided so that the same part of the search space is not searched in the same way multiple times, particular areas of the search space can be explored in more detail than others, and so on.

As shown, one implementation of operational flow 100 uses state data 110. This state data 110 represents the current state, as understood by the search algorithm. During the first iteration of operational flow 100, the state data 110 may comprise an initial state provided to the search algorithm, or an initial state chosen within a designated search space. As explained in greater detail below, during subsequent iterations, the state data 110 may comprise a new state identified based on the execution of the previous iteration or iterations.

In some exemplary implementations, and without limitation, the state data 11 0 may be represented as values for one or more variables. As discussed above, in such an exemplary implementation, the state data may be represented like so: (a, b, c, d, e), and may represent things like the number of available computer servers, the speed of the servers, and so on. It will be understood that the number and organization of variables, the data represented by the variables, as well as the use of variables at all, is generally a function of the problem to be solved and the model used in the solution of that problem. The representation of the state is not important in the context of this invention, and the state data 110 may be represented in any fashion.

In one implementation of operation 130, the search algorithm evaluates the state data 110 using a particular model associated with the problem being explored by the search algorithm. The model provides a representation of some behavior used as part of solving the problem. Given some state, the model provides a result. The model may be implemented using any of a variety of methods and may change depending on the nature of the problem being solved.

The result of evaluating the model given the state data 110 is illustrated in FIG. 1 by result data 112. In some exemplary implementations, and without limitation, the result data 112 may be represented as values for one or more variables which generally, although not always, represent parameters that are to be examined to determine the suitability or fitness of the state in producing the desired result. In one example introduced above, these variables may represent things like the number of concurrent users that a given set of computer servers can support and the average response time each user of the modeled system would experience. Like with the state data 110, it will be understood that the number and organization of variables, the data represented by the variables, as well as the use of variables at all, is a particular detail of a particular implementation of search algorithm exploration, and that the result data 112 may be represented in any fashion.

In one implementation of operation 150, the operational flow 100 determines if the stopping criteria 122 is satisfied. If it is determined in operation 150 that the stopping criteria is satisfied (“Yes” branch, operation 150), the operational flow proceeds to operation 170, described below. If it is determined that the stopping criteria is not satisfied (“No” branch, operation 150), the operational flow proceeds to operation 160, also described below.

The stopping criteria 122 can be any criteria that specifies when the search should be terminated. For example and without limitation, the stopping criteria 122 may comprise temporal criteria, such as a limit on the number of iterations or time that the search may be allowed to run. In addition, or in the alternative, other criteria such as a measure of suitability or fitness may be used. Using the example introduced above, the stopping criteria may specify that the number of concurrent users that can be supported by a set of computer servers is above a specified amount, or that the response time is below a certain specified time. Any other desired criteria may also be used, including that a suitable solution has been found by another concurrently executing search process. The possibilities for the stopping criteria 122 are virtually unlimited.

If the stopping criteria 122 has been satisfied, the operational flow 100 proceeds to operation 170 where, in one implementation, the operational flow 100 returns some search result. The search result may include, without limitation, the most recent processed state data 110. It may or may not also include the most recent result data 112. In some implementations, the search result may comprise more than one piece of state data 110, result data 112, or other data. In some implementations that return more than one set of data, some or all of the data may be stored, in the interim or for a longer period of time, in a data store, such as data store 180. Furthermore, in some cases, the operational flow 100 may return no value. For example, and without limitation, if the operational flow executes a specified number of times without finding result data 112 that meets some specified criteria, operation 170 may return no result. Another example of when operation 170 may return no result is, in some implementations, when the operational flow stops because another instance of the operational flow has found a solution. Alternatively, in other implementations, operation 170 may return the data that most closely matched some criteria, or some other set of data that may be in some way useful to the user of the search algorithm.

If the stopping criteria 122 has not been satisfied, the operational flow 100 proceeds to operation 160. In one implementation of operation 160, the operational flow 100 identifies a new state to be used in a subsequent iteration of the operational flow. After completing execution of operation 160, the operational flow proceeds again to operation 130, where the state identified in operation 160 is used.

The method by which operation 160 identifies a new state may vary greatly. In some implementations, the operational flow may identify a new state through a process the operational flow executes as part of operation 160. For example, operation 160 may use an algorithm to identify a new state given data such as, and without limitation, the existing state and the suitability of the existing state. In the same or other implementations, operation 160 may identify a new state by obtaining the new state from, for example, some other process or input outside the scope of operation 160. For example, and without limitation, some other process, including another search process, may identify a new state which is then used by operation 160.

Depending on the particular search algorithm used and other choices, the details of how the next state is identified may change drastically. For example, in some implementations, the next state may be identified randomly. In other implementations, the next state may be identified from a family of states related in some manner to the current state, for example by using “genetic” algorithms, the “slope” of current and recent results, or some other method, and so on. In the context of this invention, any such algorithm or process may be used to identify a next state.

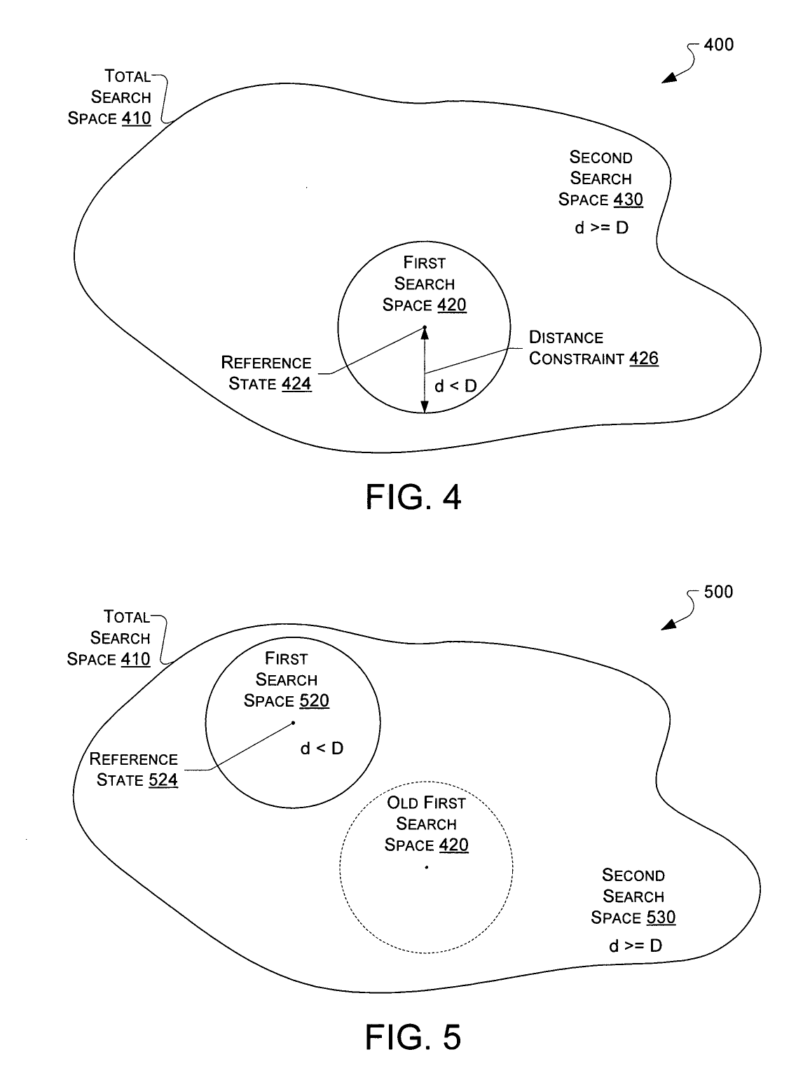

In one particular implementation, the next state may be constrained, by itself or in addition to other constraints or criteria, and using any particular algorithm, by partition criteria 118. The partition criteria 118 may include both a “distance constraint” and a “reference state.” Depending on the choice of the distance constraint and the reference state, a large variety of different search behaviors can be obtained. Some examples of the search behaviors that may result from different choices for partition criteria parameters are explained below with reference to FIG. 4 through FIG. 9.

Depending on the exact embodiment and implementation, partition criteria 118 may be identified in a number of ways. By way of example, and not limitation, a search process operating according to operational flow 100 may select partition criteria 118 itself, based on some criteria or, perhaps, based on exchange of information with other search processes. In the alternative, partition criteria 118 may be obtained from another source, such as a control or coordinating process or another search process acting as a control or coordinating process. Other options are also available, and any method of identifying partition criteria 118 may be used.

A distance constraint provides some measure of the difference between two or more states. In one or more implementations, one of the states to which the distance constraint is relative may be the “reference state.” In some implementations, the reference state may be the original state data provided to the search algorithm. In other implementations, or in the same implementation at another time, the reference state may contain some other state data. In some implementations of operation 160, the distance constraint that is part of the partition criteria 118 may be used to evaluate if the reference state is similar to the identified new state, to the existing state data 110, or to some other state data, to some specified degree. In other implementations, the distance constraint may be used to evaluate if the reference state is different, again to some specified degree, from the identified new state.

In one exemplary implementation, the distance constraint may be implemented using the “Hamming distance.” The Hamming distance is a measure of the number of changes that must be performed on one state to make it the same as another state. For example, suppose variables (A, B, C), a state (a, b, c), and another state (a, f, g). The Hamming distance between these states is two, because, to make the first state identical to the second state, the value of B would have to change from ‘b’ to ‘f,’ and the value of C would have to change from ‘c’ to ‘g.’ In some cases, for example when it is used with some local search algorithms, the Hamming distance may represent the number of intermediate states between a beginning state and an ending state.

In the same or other implementations, other operations or methods may be used as part of the implementation of the distance constraint. For example and without limitation, in a case where the state data is represented using vectors, a distance constraint may be implemented using vector operations like, for example and without limitation, the projection of a vectors onto another vector, the projection of a vector or vectors onto a surface, and so on.

Depending on the algorithm used with the distance constraint, the particular limiting value of the distance constraint, and the choice of which states to use for purposes of evaluating the distance constraint, a wide variety of search exploration behaviors may be obtained. For example, and without limitation, in one use of operational flow 100, operation 160 may define the reference state to be the initial state provided to the search algorithm, and may use a distance constraint so that it only identifies new states where the distance measure from the reference state is less than a designated value. In another example, operation 160 may use a different distance constraint to only identify new states where the distance measure with respect to the reference state is greater than some other value. In yet another example, operation 160 may use a distance constraint that specifies that only states with a distance measure between two values, or within a specified range, are to be identified. Operation 160 may use the distance measure with many different states and values to direct or constrain the search exploration.

Choosing different values for the partition criteria parameters of distance criteria and reference state may be useful when multiple instances of the search take place concurrently using multiple individual computing resources (or in sequence, or through time-sharing, on a single computing resource). For example, one instance of the search algorithm may be directed to explore those states that are within a specified distance measure from the reference state. Another instance of the search algorithm may be directed to explore those states that are greater than a specified distance measure from the same reference state. One possible exemplary system that uses one or more instances of a search algorithm is described below with reference to FIG. 2.

Turning now to FIG. 2, shown therein is an exemplary generalized system 200 that uses one or more instances of search algorithms to explore a search space. Included in the system 200 are one or more search processes 210, 212, and 214 and a coordinating or control process 260. In some implementations, one or more of the search processes 210, 212, and 214 may contain a coordinating or control element 270, 272, and 274. Also used by the system are various data elements, including one or more instances of partition criteria 220, 222, and 224; one or more instances of other data 230, 232, and 234; one or more instances of output data 250, 252, and 254; and ending output data 280.

While this description of FIG. 2 may be made with reference to other figures, it should be understood that the exemplary system 200 is not intended to be limited to being associated with the systems or other contents of any specific figure or figures.

In one or more implementations, the one or more search processes 210, 212, and 214 execute an operational flow designed to search a given portion of the search space based on given partition criteria 220, 222, and 224 and other data 230, 232, and 234. For example, a search process may execute the operational flow 100 described with respect to FIG. 1, or some suitable modification thereof. In other implementations, the one or more search processes 210, 212, and 214 may execute other operational flows. In some implementations, each search process may run on a particular individual computing resource, like a particular core in a computer processor with multiple cores, a particular computer processor, or a particular computer in a distributed set of multiple computers. In other implementations, one or more of the search processes may share a given computing resource. Any number of search processes may be used; different implementations may use different numbers of search processes depending on factors like the complexity of the problem being solved, the number of individual computing resources available, and so on.

A search process executing an operational flow may use some provided partition criteria 220, 222, and 224 as well as, in some implementations, other data 230, 232, and 234.

As discussed in greater detail below, the search topography for the overall system is determined by, inter alia, the specific data contained or referenced by the partition criteria 220, 222, and 224 and the number of search processes utilized. In some implementations, some search processes may have the same or similar partition criteria while others have different partition criteria. Similarly, the various search processes may use the same or different other data.

The partition criteria 220, 222, and 224 may include both distance constraint and reference state information, as discussed in more detail above. The partition criteria used by a search process may include a single distance constraint and reference state set, or may include multiple sets of distance constraint and reference state information. In this latter case, with multiple sets of distance constraint and reference state information, the search process may use only some or all of the distance constraint and reference state information.

The other data 230, 232, and 234 may include, inter alia, any additional data necessary or useful for the search process to identify output data 250, 252, and 254. In some implementations, the other data 230, 232, and 234 may include, but is not limited to, stopping criteria. In some implementations, no other data 230, 232, and 234 may be needed or required, and this data element may not exist or be used by the system.

Using the provided partition criteria 220, 222, and 224 and other data 230, 232, and 234, and an operational flow such as operational flow 100, a search process 210, 212, and 214 identifies output data 250, 252, and 254. The output data 250, 252, and 254 may contain a variety of information. This information may include any of the information generated as part of the executed operational flow, like operational flow 100, and/or other information. For example, and without limitation, the output data 250, 252, and 254 may include one or more states identified by the search process. In some cases, these one or more states may represent a suitable solution or solutions for the problem being solved, at least as have been found by the particular search process working with the provided partition criteria and, possibly, other data. In the same or other implementations, the output data may include the number of states explored, a measure of the suitability or fitness of the states returned or explored, and/or other data.

The output data 250, 252, and 254 may then be used by the coordinating or control process 260, which may identify some ending output data 280 or may identify a new set of partition criteria 220, 222, and 224 and, possibly, other data 230, 232, and 234 which are then used to perform additional exploration of the search space by again using the search processes 210, 212, and 214.

The ending output data 280 may comprise a variety of information. In some exemplary implementations, the ending output data 280 may include one or more states that have been identified by the search processes 210, 212, and 214 and judged by the search processes and/or the coordinating or control process 260 to be relevant to the user of the system 200. For example, and without limitation, the ending output data 280 may include the single most suitable output state found by any of the search processes throughout all iterations of the operational flows used by the system 200. In other exemplary implementations, the ending output data may contain multiple output states. The ending output data may also contain other information useful to the user of the system such as, and again without limitation, the detailed result data 112 generated by the operational flow 100, or the like. The ending output data may also contain information generated by the coordinating or control process, including, for example and without limitation, an aggregate summary of the search exploration process, or other data.

The coordinating or control process 260 may determine whether to stop execution and return some ending output data 280 using a variety of methods. In some implementations, the coordinating or control process may return ending output data when the output data 250, 252, and 254 falls within some threshold provided by the user of the system 200. For example, it may only return ending output data when the output data is above a certain value or when the result data 112 of the output data is within a specified range. In the same or other implementations, the coordinating or control process 260 may return ending output data when it has executed the operational flows used by the search processes 210, 212, and 214 some number of times. For example, it may only execute a fixed number of iterations or for a given amount of time and then possibly return some ending output data 280.

If the coordinating or control process 260 does not return ending output data 280, it may instead identify a new set of partition criteria 220, 222, and 224 and, possibly, other data 230, 232, and 234 which may then be used to perform additional exploration of the search space by again using the search processes 210, 212, and 214. The manner in which the coordinating or control process 260 identifies such data, and/or the nature of the data itself, may vary widely.

The new partition criteria 220, 222, and 224 and new other data 230, 232, and 234 may be the same for some search processes or may be different across some or all search processes. For example, in one implementation, the coordinating or control process 260 may use the same reference state data and other data and only vary the distance constraint data. In other implementations, the coordinating or control process 260 may vary both the reference state and distance constraint for some or all of the search processes. Some examples of the search behaviors that result from different partition criteria are explained below with reference to FIG. 4 through FIG. 9.

The coordinating or control process 260 may use any method to identify the new partition criteria 220, 222, and 224 and new other data 230, 232, and 234. In one or more exemplary implementations, the coordinating or control process 260 may identify only a single reference state for all search processes, and may identify that state by identifying the most suitable state from the previous iteration, as provided in the output data 250, 252, and 254. In other implementations it may identify the reference state using some other means, or may identify different reference states for different search processes. Similarly, the coordinating or control process 260 may use different distance constraints for each search process to, for example, divide the search space into different partitions and so direct the exploration in a number of different ways.

In some implementations, the identification of output data, partition criteria, and/or of new states for exploration may be performed in one or more coordinating or control elements 270, 272, and 274, instead of in a single coordinating or control process 260. In some implementations, these coordinating or control elements may be associated with one or more search processes 210, 212, and 214. One possible implementation of an operational flow that identifies ending output data and new states for exploration using elements like one or more coordinating or control elements is discussed in more detail below, with reference to FIG. 3.

In some of such implementations, and without limitation, only a single coordinating or control element 270 may be necessary to direct and coordinate or control the overall search exploration process among multiple search processes 210, 212, and 214. For example, the first search process to start may detect that it is the first search process and assume control of any search processes that start afterwards. In other implementations, and again without limitation, each search process 210, 212, and 214 may have its own coordinating or control process 270, 272, and 274. In such a system, the coordinating or control processes may communicate with each other to determine when to stop the overall search exploration process and to identify new states to explore, new partition criteria to be used, and so on. In yet other implementations, some but not all of the search processes may contain coordinating or control elements.

Turning now to FIG. 3, shown therein is an exemplary generalized operational flow 300 including various operations that may be performed to use search algorithms to explore a search space, without a centralized partitioning agent or logic. The exemplary operational flow 300 explores a search space and, in some implementations, directs its searches by communicating with other systems executing an operational flow, possibly like operational flow 300.

While this description of FIG. 3 may be made with reference to other figures, it should be understood that the exemplary operational flow 300 is not intended to be limited to being associated with the systems or other contents of any specific figure or figures. Additionally, it should be understood that while the exemplary operational flow 300 indicates a particular order of operation execution, in one or more alternative implementations, the operations may be ordered differently. Furthermore, some of the steps and data illustrated in the exemplary operational flow 300 may not be necessary and may be omitted in some implementations. Finally, while the operational flow contains multiple discrete steps, it should be recognized that in some environments some of these operations may be combined and executed at the same time.

The system 200 of FIG. 2 demonstrates one use for the exemplary operational flow 100, which explores a search space for a possible solution or solutions to a problem. While one implementation of the system 200 uses a coordinating or control process 260 to guide the overall operation of the search processes 210, 212, and 214 that execute the operational flow 100, the use of a single partitioning agent, such as the coordinating or control process 260, is not needed in all implementations.

In other implementations, guidance of the search processes 210, 212, and 214 may be performed using some other method. For example, the operational flows executed by the search processes may themselves identify ending output data and new states to explore, and no centralized partitioning logic may be required. For example, and without limitation, each search process 210, 212, and 214 may execute an operational flow like that of operational flow 300. This may occur through the use of, interalia, one or more coordinating or control elements 270, 272, and 274, or may occur through some other element, or within a search process itself. In such an implementation, or in other implementations, the exchange/partition operation 330 may achieve some or all of the same functionality provided by the coordinating or control process 260. In one or more implementations, multiple search processes may each execute operational flow 300 concurrently, and may exchange data or otherwise communicate to further direct the exploration.

As shown, one implementation of operation 310 explores a search space. The exploration may be achieved using an operational flow like that of operational flow 100 of FIG. 1, discussed above, or through the use of some other operational flow. In the example where operational flow 100 is used, after operational flow 300 proceeds from operation 310, any of the data used or generated by the operational flow 100 is available to subsequent operations in the operational flow 300. This data includes, but is not limited to, the state data 110, including both the initial state and the states explored during the search, and the result data 112.

In one implementation of operation 320, the operational flow 300 determines if this instance of the operational flow should stop execution. If it is determined in operation 320 that this instance of the operational flow 300 should stop, the operational flow 300 ends (“Yes” branch, operation 320). If it is determined that the operational flow 300 should not stop, the operational flow proceeds to operation 330 (“No” branch, operation 320), described below.

The criteria used by operation 320 to determine if the operational flow should stop execution can vary widely. For example, in one implementation and without limitation, operation 320 may decide to stop execution of the operational flow when one or more of the results returned by the execution of operation 310 falls within an acceptable range. In another or the same implementation, and also without limitation, operation 320 may stop execution of the operational flow when the operational flow 300 has executed for some number of set iterations or for a certain amount of time. In yet another implementation or implementations, operation 320 may stop execution of the operational flow 300 when some other operational flow has found a suitable solution.

In some implementations, operation 320 may only stop execution of the particular instance of operational flow 300. In the same or other implementations, operation 320 may also, directly or indirectly, stop execution of one or more other concurrently executing instances of operational flow 300. For example, in some implementations, if this particular instance of operational flow 300 identifies an acceptable solution to the problem, operation 320 may stop execution and also communicate that all other instances of operational flow 300 should also stop execution.

If the operational flow 300 does is not stopped by operation 320, the operational flow proceeds to operation 330. In one or more implementations of operation 330, data may be exchanged with other concurrently executing instances of operational flow 300 and decisions about a manner in which to partition or further explore the search space may be made and communicated between one or more of the instances of operational flow 300.

The data exchanged and the manner in which the search space is partitioned may vary widely. In one or more implementations, for example and without limitation, a particular instance of operational flow 300 may identify particular partition criteria for the next iteration. This instance of the operational flow 300 may then communicate all or part of the chosen partition criteria, and possibly instructions about other partitions to search, to other instances of the operational flow 300. The other instances of the operational flow 300 may then search according to the instructions provided by the first instance of the operational flow.

In one or more other implementations of operation 330, each instance of the operational flow 300 may identify preferable values for partition criteria, which it then communicates to the other instances executing the operational flow 300. Some logic within each instance of operation 330 may then evaluate how the particular partition criteria it initially chose compares to the partition criteria chosen by other instances of the operational flow. In some implementations, operation 330 may identify new partition criteria and then communicate this new partition criteria to the other instances executing operation 330. In some implementations this process of choosing candidate partition criteria, communicating with other instances of operational flow 300, and updating the chosen partition criteria may execute any number of times until, for example, the chosen partitions converge or otherwise are deemed suitable.

Like with partition criteria discussed with reference to FIG. 1 and FIG. 2, in some implementations, the partition criteria used by an instance of operational flow 300 may be the same as the partition criteria used by other instances of operational flow 300. In the same or other implementations, the partition criteria used by one instance of operational flow 300 may be different than the partition criteria used by another instance of operational flow 300. Further, partition criteria may be different because of different reference states, different distance constraints, or both. Similarly, any other data used by an instance of the operational flow 300 may be the same or different than the other data used by other instances of operational flow 300.

It should be understood that the manner in which operation 330 identifies the partition criteria to be used for the next iteration of the operational flow may vary widely and should not be limited in any way by the previous examples.

FIG. 4 through FIG. 9 will now explore example search topologies that may be obtained by using a variety of partition criteria with multiple search processes. As previously discussed, partition criteria may comprise a reference state and a distance constraint. A search topology may be created by identifying either the same or different values for the reference state and distance constraint, for multiple search processes. Although in some cases the topologies illustrated with respect to FIG. 4 through FIG. 9 may be considered to be relatively static, they may also be combined so that a search topology evolves over time or changes throughout the overall search.

In each of FIG. 4 through FIG. 9, a suitable implementation of how the illustrated topology might be implemented may be those systems and operational flows discussed previously with respect to FIG. 1 through FIG. 3. For example, a topology that illustrates two search spaces might utilize a search process 210 and a search process 212, both described above with respect to FIG. 2. Any other implementation, or variant thereof, may also be used. In an implementation that uses the operational flow 100 described with respect to FIG. 1, operation 160 might use the partition criteria discussed below to constrain the new states it identifies.

While the descriptions of FIG. 4 through FIG. 9 may be made with reference to other figures, it should be understood that the illustrations in FIG. 4 through FIG. 9 are not intended to be limited to being associated with the systems or other contents of any specific figure or figures. In addition, as the illustrations in FIG. 4 through FIG. 9 provide a generalized representation of an exemplary set of data, for purposes of explication, nothing additional should be inferred from the nature or organization of the illustrated shapes, or from the identification of example data values. While the illustrations described herein may be represented using a two-dimensional space, which may be a suitable representation for a problem space modeled using two variables, it should be understood that the problem space and methods of search exploration can be represented using any number of variables or any other representation. For example, the problem space and methods of search exploration may be represented, in part or in whole, using a hyperplan created by the Cartesian product of the variables used to represent a state.

Turning now to FIG. 4, shown therein is an exemplary generalized representation of a system 400 that illustrates one of many possible search topologies by showing the division of a search space into two search spaces. Shown in the system 400 are a total search space 410, a first search space 420, a second search space 430, a reference state 424, and a distance constraint 426. Note that each of the subsequent search topologies described below with respect to FIG. 5 through FIG. 9 may contain some similar elements and that discussion of these similar elements may not be repeated for each illustration.

The search topology illustrated with respect to FIG. 4 might result from using different partition criteria to divide the total search space 410, which represents the entire problem area that can be searched for a solution, into a search space to be processed by a first search process and a search space to be processed by a second search process. In the exemplary system 400, the reference state for both the first search process and the second search process might be the same, and might be represented by reference state 424. The distance constraint for the first search process might be “d<D,” and might be represented by distance constraint 426. In this context, “d<D” might indicate that the distance measure for the states searched by the first search process should be less than some value D, from the reference state 424. In contrast, the second search process might have a distance constraint of “d>=D,” which might constrain the states considered by the second search process to those that have a distance measure of greater than or equal to the same value D, again, in this example, judged relative to the same reference state 424.

These choices of partition criteria might result in the first search space 420 being searched by the first search process and the second search space 430 being searched by the second search process.

While there are many possible uses for a search topology like that shown with respect to FIG. 4, one possible use might be to search a particular area of the total search space 410 in detail, using the first search space 420, while the remainder of the total search space 410 is searched, perhaps in less detail, by the second search space 430.

Turning now to FIG. 5, shown therein is an exemplary generalized representation of a system 500 that illustrates how a search may change over time by using new partition criteria. This specific example shows one possible change in search topology from the search topology described above with respect to FIG. 4. Shown in the system 500 are the total search space 410, a first search space 520, a second search space 530, an old first search space 420 (which is the same as the first search space 420), and a reference state 524.

The search topology illustrated with respect to FIG. 5 might show one possible way in which a search using two search processes might be directed and change over time, in this case from the search topology illustrated with respect to FIG. 4. Similar to the exemplary system 400, in the exemplary system 500 the reference state for both the first search process and second search process is the same: reference state 524, while the distance constraints are different “d<D” and “d>=D.” However, because the reference state 524 has changed from the reference state 424 in system 400, the first and second search processes now search different parts of the total search space 410.

By periodically changing the partition criteria, perhaps in a way similar to that illustrated with respect to FIG. 5, or in some other way, the overall search may proceed to find increasingly suitable solutions. For example and without limitation, in an implementation like that illustrated with respect to FIG. 4 and FIG. 5, where one search process undertakes a detailed search, while another search process performs a more general search, the search processes may occasionally exchange and compare their most suitable solutions. In one implementation, this may enable a more detailed search to be performed on a, possibly more suitable, search space located by a general search.

In one implementation, the change in partition criteria might be associated with the coordinating or control process 260 or coordinating or control elements 270, 272, and 274 described above with respect to FIG. 2, and/or as a result of the execution of the “partition/exchange” operation 330 described above with respect to FIG. 3. In other implementations, the change in partition criteria might be associated with some other system element or operation.

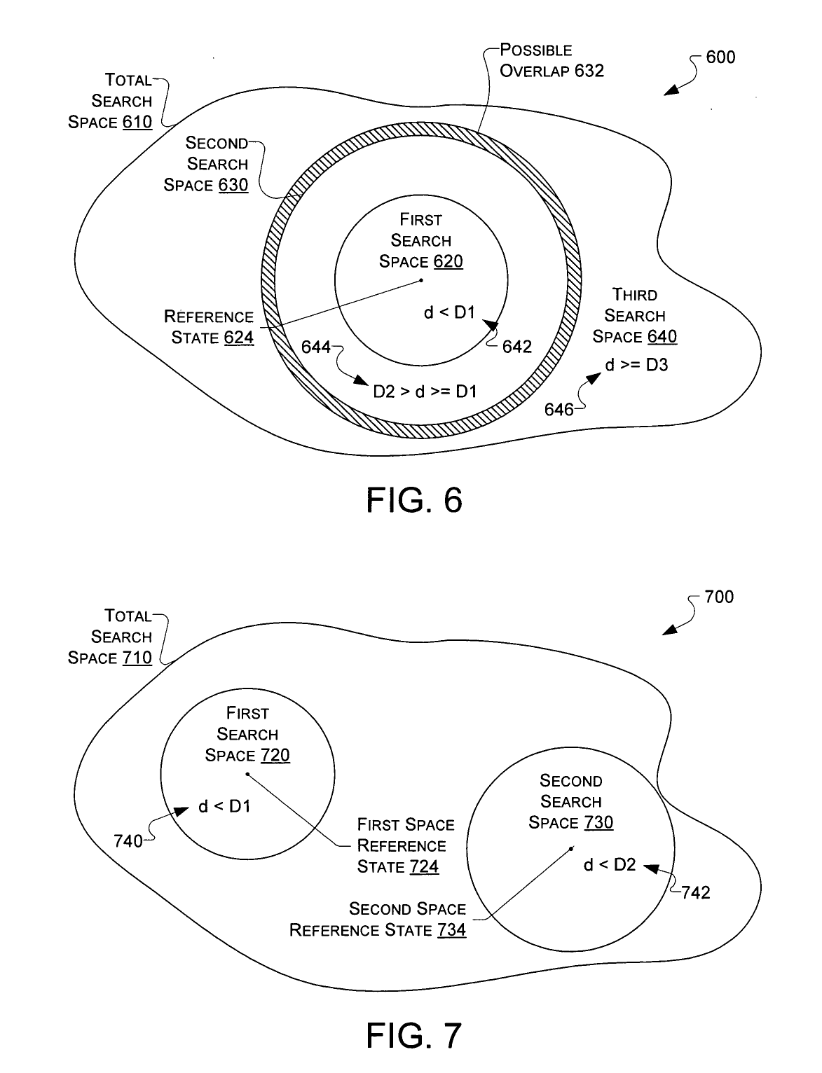

Turning now to FIG. 6, shown therein is an exemplary generalized representation of a system 600 that illustrates one of many possible divisions of a search space into three search spaces. Shown in the system 600 are a total search space 610, a first search space 620, a second search space 630, a third search space 640, and a reference state 624.

The search topology illustrated with respect to FIG. 6 might result from using different partition criteria to divide the total search space 610 into three search spaces, each of which is processed by a search process. The first search process might search the first search space 620, the second search process might search the second search space 630, and the third search process might search the third search space 640.

In the exemplary system 600, the reference state for each search process might be the same: reference state 624. The distance constraint for the first search process might be “d<D1,” for the second process “D2>d>=D1,” and for the third search process “d>=D3.” The distance constraints for the first search space 620 (distance constraint 642) and the third search space 640 (distance constraint 646) are similar to those illustrated previously with respect to FIG. 4 and FIG. 5, in that they may define a search space where the distance measure for the searched states is less than some value, like D1 (in the case of the first search space 620) or greater than or equal to some value, like D3 (in the case of the second search space 640). The partition criteria for the second search space 630 uses a distance constraint 644, “D2>d>=D1,” that incorporates two specified values so that it searches states that are, in a sense, “between” those of the first search space 620 and the second search space 640.

Depending on how D2 and D3 are selected, it is possible to deliberately create an area of overlap between the search spaces. For example if D2>D3 in some sense, then an area of overlap, illustrated as 632, may be created. If, on the other hand, D2=D3, then no area of overlap would be created. The possible overlap 632 is illustrated to show the flexibility that is available using the partitioning mechanisms described herein.

Turning now to FIG. 7, shown therein is an exemplary generalized representation of a system 700 that illustrates a division into two search spaces where the reference states are not the same, and where the search spaces do not encompass all of the total search space. Shown in the system 700 are a total search space 710, a first search space 720, a second search space 730, a first space reference state 724, and a second space reference state 734.

The search topology illustrated with respect to FIG. 7 might result from using different partition criteria to divide the total search space 710 into a first search space 720 and a second search space 730, each of which is processed by a search process. In contrast to some of the examples discussed previously, the system 700 illustrates a search topology where the reference states that are part of the partition criteria are not the same. In this example, the reference state for the first search space is illustrated by the first space reference state 724 while the reference state for the second search space is illustrated by the second space reference state 734. In addition, the distance constraints that are a part of each partition criteria are also different, both in the reference state to which they are relative, and in the distance constraints themselves. The distance constraint 740 for the first search space 720 is “d<D1” while the distance constraint 742 for the second search space 730 is “d<D2.” The illustrated size of the resulting second search space 730 is larger than that of the first search space 720, which may imply in some examples that D2 is larger than D1, although this is not required.

Finally, the system 700 also demonstrates that not all of the total search space 710 is searched. The exemplary system 700 has only two search processes, each of which searches a detailed area “around” its own reference state. The portion of the total search space 710 that is outside of these areas is not searched. While it may be useful in some cases, there is no requirement that the entire search space be covered by at least one search space. In addition, in some implementations, a further iteration, where one or more of the partition criteria may change, may then encompass a portion of or all of the search space that is not currently being searched.

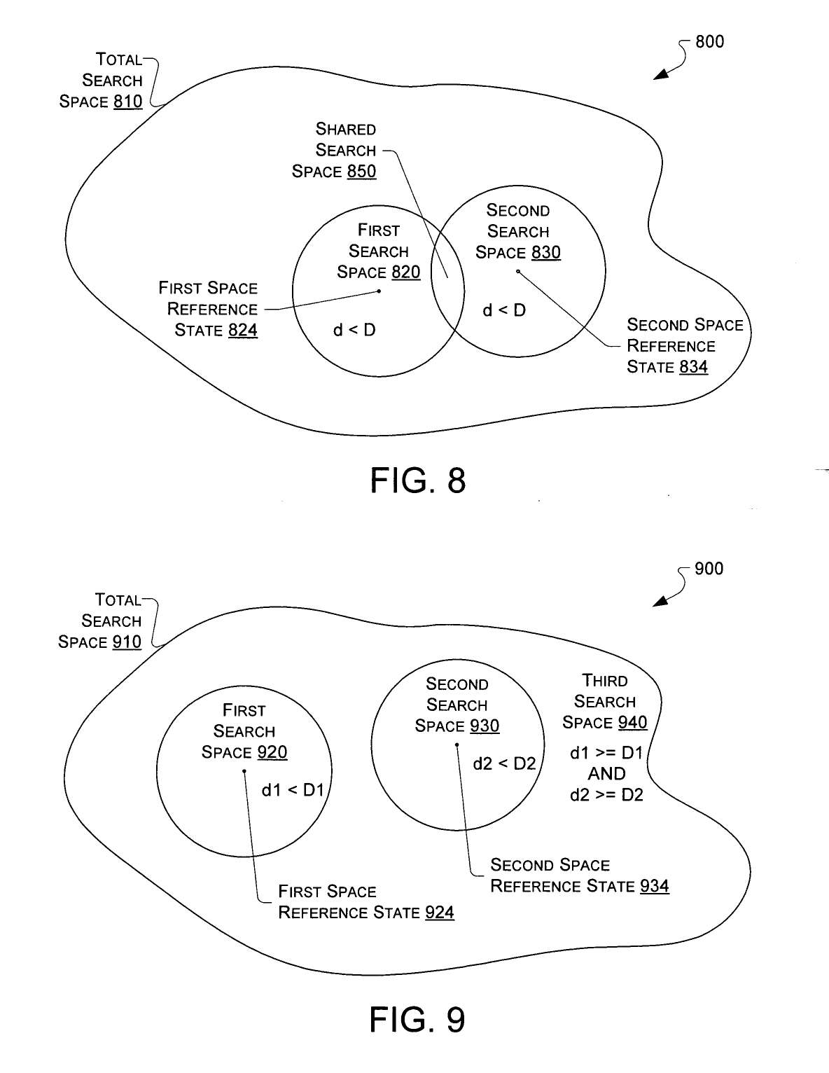

Turning now to FIG. 8, shown therein is an exemplary generalized representation of a system 800 that illustrates a division into two search spaces where the reference states are not the same, and where the resulting search spaces overlap. Shown in the system 800 are a total search space 810, a first search space 820, a second search space 830, a first space reference state 824, a second space reference state 834, and a shared search space 850.

Like with some of the previously discussed examples, the search topology illustrated with respect to FIG. 8 might result from using different partition criteria to divide the total search space 810 into a first search space 820 and a second search space 830, each of which is processed by a search process. As shown, the reference states for the two search spaces are different: the first search space uses the first space reference state 824 while the second search space uses the second space reference state 834.

The particular choices for partition criteria in this exemplary system happen to result in a portion of the total search space 810 being searched by both search processes. This overlapping portion is illustrated by the shared search space 850. As this example demonstrates, there is no requirement that search processes always explore search spaces that are not the same.

Turning now to FIG. 9, shown therein is an exemplary generalized representation of a system 900 that illustrates a division into three search spaces where the third search space is defined using partition criteria that contains multiple reference states and distance constraints. Shown in the system 900 are a total search space 910, a first search space 920, a second search space 930, a third search space 940, a first space reference state 924, and a second space reference state 934.

The first search space 920 and second search space 930 are defined using partition criteria similar to partition criteria discussed above with reference to FIG. 7, for example. They use different reference states, the first space reference state 924 and second space reference state 934, respectively, as well as distance constraints that define a search space containing states within a distance measure specified by a set value, D1 and D2 respectively in this example.

In contrast, the third search space 940 is defined in a different manner than some other search spaces have been defined. The third search space 940 is defined using partition criteria that contains two reference states and two distance constraints. In this example, the third search space 940 is defined using a distance constraint of “d1>=D1,” judged from the first space reference state 924, and using a distance constraint of “d2>=D2,” judged from the second space reference state 934. In this example, this partition criteria constrains the states considered by the third search process to only those that are not part of the first search space 920 or part of the second search space 930.

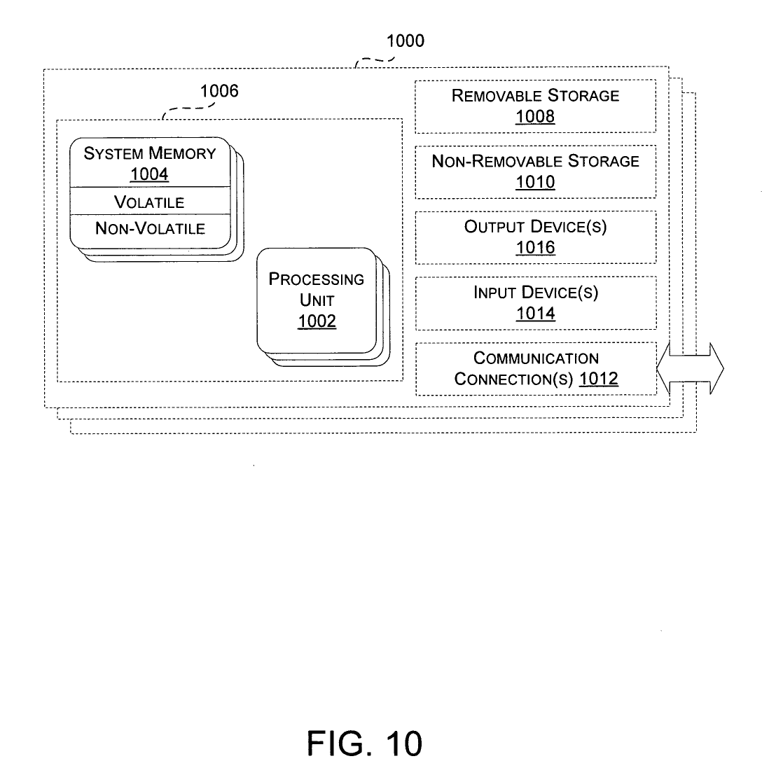

Turning now to FIG. 10, shown therein is one possible basic implementation of a computing device. FIG. 10 and the related discussion are intended to provide a brief, general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 1000 illustrated in FIG. 10.

Generally, program modules include routines, programs, objects, components, data structures, etc., that perform particular tasks or implement particular abstract data types. Tasks performed by the program modules are described previously with the aid of block diagrams and operational flowcharts.

Those skilled in the art can implement the description, block diagrams, and flowcharts in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

The computing device 1000 of FIG. 10, in its most basic configuration, includes at least one processing unit 1002 and memory 1004. Depending on the exact configuration and type of computing device, the memory 1004 may be volatile (such as RAM), non-volatile (such as ROM, flash memory, etc.), or some combination of the two. This most basic configuration is illustrated in FIG. 10 by dashed line 1006. Additionally, the computing device 1000 may also have additional features/functionality. For example, the computing device 1000 may also include additional storage (removable and/or non-removable) including, but not limited to, magnetic or optical disks or tape. Such additional storage is illustrated in FIG. 10 by the removable storage 1008 and the non-removable storage 1010.

The computing device 1000 may also contain one or more communications connection(s) 1012 that allow the computing device 1000 to communicate with other devices. The computing device 1000 may also have one or more input device(s) 1014 such as keyboard, mouse, pen, voice input device, touch input device, etc. One or more output device(s) 1016 such as a display, speakers, printer, etc. may also be included in the computing device 1000.

Those skilled in the art will appreciate that the technologies described herein may be practiced with computing devices other than the computing device 1000 illustrated in FIG. 10. For example, and without limitation, the technologies described herein may likewise be practiced in hand-held devices, multiprocessor systems, microprocessor-based or programmable consumer electronics, network PCs, minicomputers, mainframe computers, and the like.

The technologies described herein may also be implemented in distributed computing environments where tasks are performed by remote processing devices that are linked through a communications network. In a distributed computing environment, program modules may be located in both local and remote memory storage devices.

While described herein as being implemented in software, it will be appreciated that the technologies described herein may alternatively be implemented all or in part as hardware, firmware, or various combinations of software, hardware, and/or firmware.

1. A method comprising:
a. identifying, for each process searching in a search space, at least one reference search state within the search space; and
b. identifying, for each process searching in the search space, at least one distance constraint to be used, along with the at least one reference search state, to select current search states within the search space.

2. The method of claim 1 wherein each process searching in the search space performs a method comprising:
c. identifying a current search state based on the at least one distance constraint and the at least one reference state;
d. evaluating a model using the current search state;
e. selecting a new state based on at least the at least one distance constraint and the at least one reference state and using the new state as the current search state; and
f. repeating steps (d) through (e) until a stopping criteria is satisfied.

3. The method of claim 2 wherein at least two processes search the search space.

4. The method of claim 3 wherein:
a. the at least one reference search state within the search space is the same for each process searching in the search space; and
b. the at least one distance constraint for each process searching in the search space is selected in order to partition the search space into regions.

5. The method of claim 4 wherein at least two regions overlap at least partially.

6. The method of claim 4 wherein at least two regions are non-overlapping.

7. The method of claim 3 wherein:
a. at least one distance constraint is different for at least one process searching in the search space than for other processes searching in the search space.

8. The method of claim 3 wherein:
a. at least one reference search state within the search space is different for at least one process searching in the search space than for other processes searching in the search space.

9. The method of claim 8 wherein the at least one distance constraint for each process searching in the search space is selected in order to partition the search space into regions.

10. The method of claim 9 wherein at least two regions overlap at least partially.

11. The method of claim 9 wherein at least two regions are non-overlapping.

12. The method of claim 2 wherein at least two processes each execute the method of claim 2 and wherein at least one of the at least two process further exchanges its at least one reference search state with at least one other of the at least two processes.

13. The method of claim 2 wherein each process searching in the search space:
a. identifies its own at least one reference search state;
b. identifies its own at least one distance constraint; and
c. wherein each process searching in the search space further performs a method comprising:
i. exchanging information comprising its at least one reference state with at least one of the at least two processes;
ii. performing (c) through (f) of claim 2; and when the stopping criteria of (f) is satisfied then
iii. identifying a new at least one reference state and using the new at least one reference state as the at least one reference state;
iv. identifying a new at least one distance constraint to be used, along with the at least one reference search state, to select current search states within the search space and using the new at least one distance constraint as the at least one distance constraint; and
v. repeating (i) through (iv) until a global stopping criteria is reached.

14. The method of claim 2 wherein:
g. identifying, by a coordinating process for each process searching in a search space, at least one reference search state within the search space; and
h. identifying, by a coordinating process for each process searching in the search space, at least one distance constraint to be used, along with the at least one reference search state, to select current search states within the search space; and
i. wherein each process searching in the search space further performs (c) through (f) of claim 2; and when the stopping criteria of (f) is satisfied then
j. identifying, by the coordinating process, a new at least one reference state and using, by the processes searching the search space the new at least one reference state as the at least one reference state;
k. identifying, by the coordinating process, a new at least one distance constraint to be used by the processes searching in the search space, along with the at least one reference search state, to select current search states within the search space and using the new at least one distance constraint as the at least one distance constraint; and
l. repeating (i) through (k) above until a global stopping criteria is reached.

15. Computer readable media comprising executable instructions to perform the method of claim 1.

16. Computer readable media having executable instructions encoded thereon comprising:
a. means for identifying at least one partition criteria in order to partition a search space into a plurality of regions, each of which represent a portion of the search space that is to be searched by a search process, each of the at least one partition criteria comprising at least one reference search state and at least one distance constraint.

17. Computer readable media as in claim 16 further comprising means for identifying a current search state based on the at least one partition criteria.

18. A system for searching a search space comprising:
a. a plurality of computing resources;
b. a plurality of search processes, executing on at least one of the plurality of computing resources;
c. at least one controlling process for identifying at least one partition criteria, the partition criteria including at least one distance measure relative to a reference state; and
d. each of the plurality of search processes adapted to select a current search state based on the at least one partition criteria.

19. A system as in claim 18 wherein at least one search process is the controlling process, the controlling process for identifying at least one partition criteria for each of the plurality of search processes, the controlling process executing on at least one of the plurality of computing resources.

20. The system as in claim 18 wherein the distance measure is a Hamming distance.
